(19) United States
(12) Patent Application Publication
(10) Pub. No.: US 2008/0124017 A1
(43) Pub. Date: May 29, 2008

(54) Wheel Bearing Apparatus and Method of Its Assembly

(75) Inventor: Mitsuru Umekida, Shizuoka-ken (JP)

Correspondence Address: HARNESS, DICKEY & PIERCE, P.L.C., P.O. BOX 828, BLOOMFIELD HILLS, MI, 48303, US

(73) Assignee: Nippon Telegraph and Telephone Corporation, Chiyoda-ku, Tokyo (JP)

(21) Appl. No.: 11/883,391

(22) PCT Filed: Jan. 17, 2006
(86) PCT No.: PCT/JP2006/300549

§ 371 Date: Nov. 2, 2007

(30) Foreign Application Priority Data
Jan. 31, 2005 (JP) 2005-022599

(51) Int. Cl. F16C 19/18; F16C 43/04; B60B 35/18; F16C 33/76

(52) U.S. Cl. 384/544; 384/477

(57) ABSTRACT

A wheel bearing apparatus formed by a unit of a wheel hub, a double row rolling bearing and a constant velocity universal joint where the double row rolling bearing has an outer member formed with double row outer raceway surfaces on its inner circumferential surface. An inner member, including the wheel hub has a wheel mounting flange integrally formed at one end. One of the double row inner raceway surfaces are formed on the inner member and is arranged opposite to the double row outer raceway surfaces. A cylindrical portion axially extends from the wheel mounting flange. Also, the inner member includes an outer joint member of the constant velocity universal joint. The outer joint member is formed with the other of the double row inner raceway surfaces. The outer joint member has a shaft portion axially extending from the other double row inner raceway surface. Double row rolling elements are rollably arranged between the outer and inner raceway surfaces. Seals are mounted in annular openings formed at opposite ends of the outer member and the inner member. The wheel hub and the outer joint member are integrally connected by plastically deforming the shaft portion of the outer joint member into the wheel hub. The inboard side seal of the seals has a sealing ring with a generally annular metal core with a substantially L-shaped cross-section adapted to be fit into the outer member. A sealing member, having side lips, is adapted to be integrally adhered on the metal core, via vulcanized adhesion. A generally annular slinger is adapted to be arranged opposite to the sealing ring. The slinger has a substantially L-shaped cross-section formed by a cylindrical portion, adapted to be fit onto the inner member, and a standing portion, extending radially outward from the cylindrical portion. A guiding portion is formed on the base of the cylindrical portion of the slinger to prevent generation of deformation or pinching during the press fitting of the slinger.

### CROSS-REFERENCE TO RELATED APPLICATIONS

This application is a National Stage of International Application No. PCT/JP2006/300549, filed Jan. 17, 2006, which claims priority to Japanese Patent Application No. 2005-022599, filed Jan. 31, 2005. The disclosures of the above applications are incorporated herein by reference.

### FIELD

The present disclosure relates to a wheel bearing apparatus that rotatably supports a wheel of a vehicle, such as an automobile, relative to its suspension apparatus and a method of its assembly and, more particularly, to a wheel bearing apparatus and a method of its assembly intended to improve the accuracy in assembly of a seal. Thus, it improves the sealability in the wheel bearing apparatus of a fourth generation type.

### BACKGROUND

Wheel bearing apparatus that supports a wheel of a vehicle has been orderly developed. In a first generation type, a double row rolling bearing is provided with seals and, is independently adopted. In a second generation type, an outer member is integrally formed with a body mounting flange. In a third generation type, a wheel hub, integrally formed with a wheel mounting flange, includes one inner raceway surface of a double row rolling bearing on its outer circumferential surface. In a fourth generation type, a wheel hub is further combined with a constant velocity universal joint. The other inner raceway surface of the double row rolling bearing is formed on the outer circumferential surface of the outer joint member, which forms the constant velocity universal joint.

FIG. 5 shows a representative example of a wheel bearing apparatus of a third generation type that has an outer member 51 integrally formed with a body mounting flange 51b. The body mounting flange 51b is to be mounted on a body (not shown) of a vehicle. Double row outer raceway surfaces 51a, 51a are formed on the outer member 51. A wheel hub 52 has an integrally formed wheel mounting flange 53 at one end. One of the double row inner raceway surfaces 52a, arranged opposite to one of the double row outer raceway surfaces 51a, 51a, is formed on the wheel hub 52. A cylindrical portion 52b axially extends from the inner raceway surface 52a. A serration, to transmit torque, is formed on the inner circumferential surface of the cylindrical portion 52b. An inner ring 55 is press fit onto the cylindrical portion 52b of the wheel hub 52. The inner ring 55 is formed with the other inner raceway surface 55a on its outer circumferential surface. Hub bolts 54 are mounted on the wheel mounting flange 53 equidistantly apart from each other along the periphery of the flange.

Double row rolling elements (balls) 56 are arranged between the double row outer and inner raceway surfaces 51a, 51a; 52a, 55a. The balls 56 are freely rollably held by cages 57. Seals 59, 60 are arranged in annular openings at both ends of an inner member 58, including the wheel hub 52 and the inner ring 55, and the outer member 51. The seals 59, 60 prevent leakage of grease contained within the bearing as well as ingress of rain water or dust into the inside of the bearing.

As shown in FIG. 6, the inboard side seal 60, arranged between the outer member 51 and the inner ring 55, comprises a sealing ring 63 that includes a metal core 61 with a substantially L-shaped cross-section. The seal 60 is fit into the outer member 51. A sealing member 62 is integrally adhered, via vulcanized adhesion, onto the metal core 61. A slinger 64, having similar L-shaped cross-section, is fit onto the inner ring 55. This slinger 64 has a cylindrical portion 64a and a standing portion 64b that extends radially outward from the cylindrical portion 64a.

The sealing member 62 is formed from an elastic material, such as rubber, and has three (3) sealing lips, a side lip 62a, a grease lip 62b and a middle lip 62c. The tip edge of the side lip 62a is adapted to be in sliding contact with the outboard side surface of the standing portion 64b of the slinger 64. The tip edges of the remaining grease lip 62b and middle lip 62c are adapted to be in sliding contact with the cylindrical portion 64a of the slinger 64. The tip of the standing portion 64b of the slinger 64 opposes the sealing ring 63 with a slight radial gap therebetween to form a labyrinth seal 65. This structure exhibits sufficient sealability under circumstances where plenty of foreign matters, such as rain water or muddy water, exist.

Assembly of the inboard side seal 60 of the third generation type is carried out by press fitting the previously united sealing ring 63 and slinger 64 into the annular space formed between the outer member 51 and the inner ring 55. A press fitting tool P is used as shown in FIG. 7. This fit obtains a desirable accuracy in assembly and sealability.

On the contrary FIG. 8 shows a representative example of a wheel bearing apparatus of the fourth generation type. It is formed as a unit including a wheel hub 70, double row rolling bearing 80 and a constant velocity universal joint 90. The double row rolling bearing 80 comprises an outer member 51, an inner member 72 and double row rolling elements (balls) 56, 56.

The inner member 71 includes the wheel hub 70 and an outer joint member 91 fit into the wheel hub 70. The inner circumferential surface of the wheel hub 70 is formed with an irregular portion 72 formed with a hardened layer having a surface hardness of HRC 54˜64. The irregular portion 72 is formed with a crisscross knurl pattern formed by combining a plurality of independent annular grooves, formed by a lathe, and a plurality of axial grooves, formed by broaching, in an orthogonally crossed manner.

The constant velocity universal joint 90 includes the outer joint member 91, a joint inner ring 92, a cage 93 and torque transmitting balls 94. The outer joint member 91 has a cup shaped mouth portion 95, a shoulder portion 96, forming the bottom of the mouth portion 95, and an integral cylindrical shaft portion 97 axially extending from the shoulder portion 96. The shaft portion 97 is formed with a cylindrical spigot portion 97a that is fit into the cylindrical portion 52b of the wheel hub 70, via a predetermined radial gap, and a fitting portion 97b at the end of the spigot portion 97a.

The outer circumferential surface of the shoulder portion 96 is formed with the other inner raceway surface 96a arranged opposite to one of the outer raceway surface 51a. A hardened layer, having the surface hardness of HRC 58˜64, is formed by high frequency induction heating in a region from a seal land portion, which sliding contacts the inboard side seal 60, to the inner raceway surface 96a and the shaft portion 97. The fitting portion 97b, itself, remains as raw material without being hardened after being forged.

The shaft portion 97 is fit into the wheel hub 70 until the shoulder portion 96 of the outer joint member 91 abuts the end face of the cylindrical portion 52b of the wheel hub 70. The wheel hub 70 and the outer joint member 91 are integrally connected to each other by inserting a radially expanding tool, such as a mandrel, into the bore of the fitting portion 97b of the shaft portion 97. The fitting portion 97b is plastically deformed and forced to bite into the hardened irregular portion 72.

In such a wheel bearing apparatus of the fourth generation type, it is impossible to carry out the assembly of the inboard side seal 60 in the same manner as it is carried out in the wheel bearing apparatus of the third generation type. This is due to the fact that the constant velocity universal joint 90 is integrated with the wheel hub 70 and one inner raceway surface 96a is formed on the outer circumferential surface of the outer joint member 91. As shown in FIG. 9(a), the assembly of the inboard side seal 60 cannot be accomplished by press fitting the sealing ring 63 into the outer member 51. Also, press fitting the slinger 64 onto the shoulder 96 using a press fitting tool P and then assembling the wheel hub 70 and the outer joint member 91 is not possible.

According to the conventional method for assembling the inboard side seal 60 of the wheel bearing apparatus of the fourth generation type, since the sealing ring 63 and the slinger 64 are previously and separately press fit, respectively, onto the outer member 51 and the outer joint member 91, the interference contact (contacting force) of the side lip 62a against the slinger 64 is substantially influenced by the positioning accuracy between the sealing ring 63 and the slinger 64. Particularly as shown in FIG. 9(b), the contact interference is influenced by dimensional errors not only in the thickness “t” of the standing portion 64b but in the width “W” of the cylindrical portion of the slinger 64. Thus, it is very difficult to have a good interference contact of the side lip 62a in the wheel bearing apparatus of the fourth generation type as compared with that of the third generation type even though careful attention is paid during the press fitting operation of the slinger 64.

### SUMMARY

It is an object of the present disclosure to provide a wheel bearing apparatus and a method of its assembly intended to improve the accuracy in assembly, sealability and assembling efficiency in assembling the inboard side seal onto the wheel bearing apparatus of a fourth generation type.

According to the present disclosure, a wheel bearing apparatus formed by a unit of a wheel hub, a double row rolling bearing and a constant velocity universal joint comprises an outer member formed with double row outer raceway surfaces on its inner circumferential surface. An inner member includes the wheel hub with a wheel mounting flange integrally formed at one end. One of the double row inner raceway surfaces, arranged opposite to the double row outer raceway surfaces, is formed on the inner member. A cylindrical portion axially extends from the wheel mounting flange. Also, the inner member includes an outer joint member of the constant velocity universal joint. The outer joint member is formed with the other of the double row inner raceway surfaces. The outer joint member has a shaft portion axially extending from the other double row inner raceway surface. Double row rolling elements are rollably arranged between the outer and inner raceway surfaces. Seals are mounted in annular openings formed at opposite ends of the outer member and the inner member. The wheel hub and the outer joint member are integrally connected by plastically deforming the shaft portion of the outer joint member into the wheel hub. The seal on the inboard side of the seals comprises a sealing ring with a generally annular metal core having a substantially L-shaped cross-section adapted to be fit into the outer member. A sealing member, with side lips, is adapted to be integrally adhered on the metal core via vulcanized adhesion. A generally annular slinger is adapted to be arranged opposite to the sealing ring. The slinger has a substantially L-shaped cross-section formed by a cylindrical portion adapted to be fit onto the inner member. A standing portion of the slinger extends radially outward from the cylindrical portion. A guiding portion is formed on the base of the cylindrical portion of the slinger to prevent generation of deformation or pinching during press fitting of the slinger.

In the wheel bearing apparatus of the fourth generation type, the inboard side seal comprises a sealing ring with a generally annular metal core having a substantially L-shaped cross-section adapted to be fit into the outer member. A sealing member, having side lips, is adapted to be integrally adhered on the metal core, via vulcanized adhesion. A generally annular slinger is adapted to be arranged opposite to the sealing ring. The slinger has a substantially L-shaped cross-section with a cylindrical portion adapted to be fit onto the inner member. A standing portion extends radially outward from the cylindrical portion. A guiding portion is formed on the base of the cylindrical portion of the slinger to prevent generation of deformation or pinching during press fitting of the slinger. Thus, it is possible to prevent deformation or pinching of the slinger during the press fitting operation. Accordingly, good seating of the slinger against the inner member (outer joint member) can be achieved. Thus, it is also possible to improve the accuracy in assembly, to keep a desirable interference contact of the side lip and improve the sealability of the inboard side seal.

The wheel hub and the outer joint member are integrally connected by plastically deforming a fitting portion formed in the shaft portion of the outer joint member. The fitting portion is forced to bite into a hardened irregular portion formed on an inner circumferential surface of the wheel hub. This makes it possible to reduce the size and weight of the wheel bearing apparatus and to improve the strength and durability of the wheel hub. Also, it maintains its pre-load for a long term.

The thickness of the slinger is larger than that of the metal core. The thickness is set within a range of 0.8 mm˜1.0 mm. Thus, it is possible to suppress the deformation of the slinger during press fitting.

A method of assembling a wheel bearing apparatus comprises the steps of fitting the sealing ring of the inboard side seal into the outer member; and press fitting the slinger by using a press fitting tool adapted to abut the outboard side face of the standing portion of the slinger.

The positioning of the slinger can be accomplished only in consideration of the press fitting stroke of the tool without consideration of variations in the thickness or width of the slinger. Thus, it is possible to further improve the accuracy in positioning and to control the interference contact of the side lip against the slinger within a predetermined range. Accordingly, this improves the efficiency in assembling the inboard side seal of the wheel bearing apparatus of a fourth generation type.

The standing portion of the slinger is previously formed so that it is inclined toward the outboard side at a predetermined angle. This makes it possible to assure a desirable perpendicularity of the standing portion relative to the cylindrical portion of the slinger even though the standing portion is deformed by the press fitting tool during the press fitting operation of the slinger.

The wheel bearing apparatus is formed by a unit of a wheel hub, a double row rolling bearing and a constant velocity universal joint. The double row rolling bearing comprises an outer member formed on its inner circumferential surface with double row outer raceway surfaces. An inner member includes the wheel hub with a wheel mounting flange integrally formed at one end. One of the double row inner raceway surfaces is formed on the inner member and is arranged opposite to the double row outer raceway surfaces. A cylindrical portion axially extends from the wheel mounting flange. Also, the inner member includes an outer joint member of the constant velocity universal joint. The outer joint member is formed with the other of the double row inner raceway surfaces. The outer joint member has a shaft portion axially extending from the other double row inner raceway surface. Double row rolling elements are rollably arranged between the outer and inner raceway surfaces. Seals are mounted in annular openings formed at opposite ends of the outer member and the inner member. The wheel hub and the outer joint member are integrally connected by plastically deforming the shaft portion of the outer joint member into the wheel hub. The seal of the inboard side of the seals include a sealing ring including a generally annular metal core with a substantially L-shaped cross-section adapted to be fit into the outer member. A sealing member, having side lips, is adapted to be integrally adhered on the metal core, via vulcanized adhesion. A generally annular slinger is adapted to be arranged opposite to the sealing ring. The slinger has a substantially L-shaped cross-section formed with a cylindrical portion adapted to be fit onto the inner member. A standing portion extends radially outward from the cylindrical portion. A guiding portion is formed on the base of the cylindrical portion of the slinger to prevent generation of deformation or pinching during press fitting of the slinger. Thus, it is possible to prevent deformation or pinching of the slinger during the press fitting operation. Thus, good seating of the slinger against the inner member (outer joint member) can be achieved. Accordingly, it is also possible to improve the accuracy in assembly, to keep a desirable interference contact of the side lip and thus improve the sealability of the inboard side seal.

The method of assembling a wheel bearing apparatus of the present disclosure comprises the steps of fitting the sealing ring of the inboard side seal into the outer member; and press fitting the slinger by using a press fitting tool adapted to abut the outboard side face of the standing portion of the slinger. Thus, it is possible to further improve the accuracy in positioning and thus to control the interference contact of the side lip against the slinger within a predetermined range. Accordingly, this improves the efficiency in assembling the inboard side seal of the wheel bearing apparatus of fourth generation type.

A wheel bearing apparatus is formed by a unit of a wheel hub, a double row rolling bearing and a constant velocity universal joint. The double row rolling bearing comprises an outer member formed with double row outer raceway surfaces on its inner circumferential surface. An inner member includes the wheel hub having a wheel mounting flange integrally formed at one end. One of the double row inner raceway surfaces is formed on the inner member and arranged opposite to the double row outer raceway surfaces. A cylindrical portion axially extends from the wheel mounting flange. Also, the inner member includes an outer joint member of the constant velocity universal joint. The outer joint member is formed with the other of the double row inner raceway surfaces. The outer joint member has a shaft portion axially extending from the other double row inner raceway surface. Double row rolling elements are rollably arranged between the outer and inner raceway surfaces. Seals are mounted in annular openings formed at opposite ends of the outer member and the inner member. The wheel hub and the outer joint member are integrally connected by plastically deforming the shaft portion of the outer joint member into the wheel hub. The inboard side seal of the seals comprises a sealing ring with a generally annular metal core having a substantially L-shaped cross-section adapted to be fit into the outer member. A sealing member, having side lips, is adapted to be integrally adhered on the metal core, via vulcanized adhesion. A generally annular slinger is adapted to be arranged opposite to the sealing ring. The slinger has a substantially L-shaped cross-section formed with a cylindrical portion adapted to be press fit onto the inner member. A standing portion extends radially outward from the cylindrical portion. A guiding portion is formed on the base of the cylindrical portion of the slinger to prevent generation of deformation or pinching during press fitting of the slinger.

### DRAWINGS

Additional advantages and features of the present disclosure will become apparent from the subsequent description and the appended claims, taken in conjunction with the accompanying drawings, wherein:

FIG. 1 is a longitudinal-section view of one embodiment of a wheel bearing apparatus in accordance with the disclosure.

FIG. 2 is a partially enlarged sectional view of FIG. 1.

FIG. 3 is an explanatory sectional view showing a method for assembling the wheel bearing apparatus.

FIGS. 4(a)˜4(e) are longitudinal-section views each showing an embodiment of a slinger of the present disclosure.

FIG. 5 is a longitudinal-section view of a conventional wheel bearing apparatus of the third generation type.

FIG. 6 is a partially enlarged sectional view of FIG. 5.

FIG. 7 is an explanatory sectional view showing a method for assembling the wheel bearing apparatus.

FIG. 8 is a longitudinal-section view of the wheel bearing apparatus of the fourth generation type.

FIG. 9(a) is an explanatory sectional view showing a method for assembling the wheel bearing apparatus of the fourth generation type.

FIG. 9(b) is a longitudinal-section view of the slinger of FIG. 9(a).

### DETAILED DESCRIPTION

A preferred embodiment of the present disclosure will be described with reference to accompanied drawings.

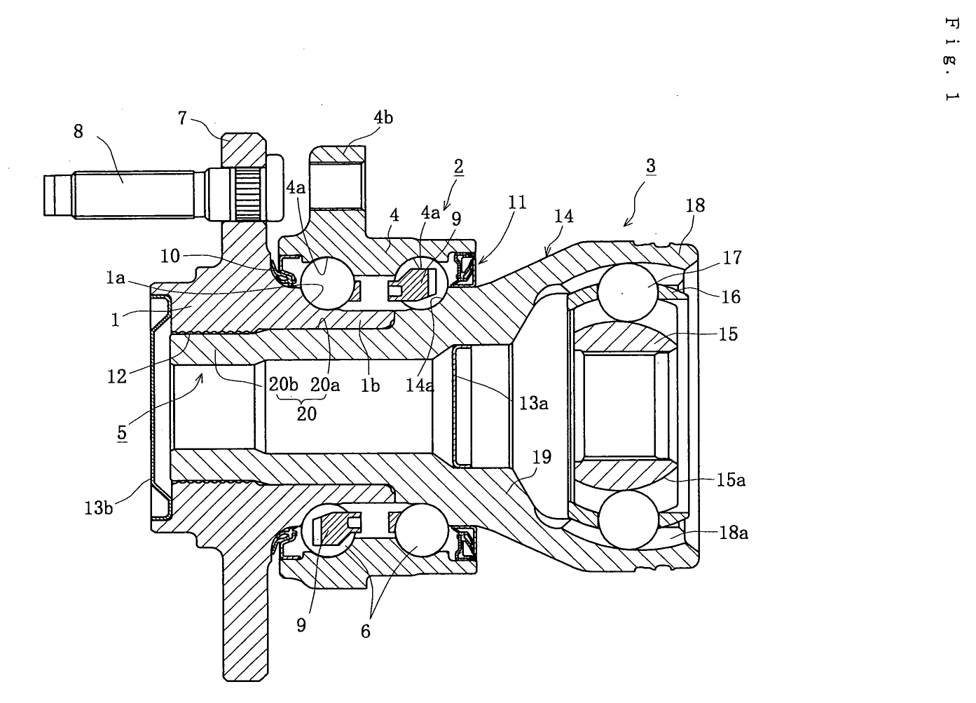

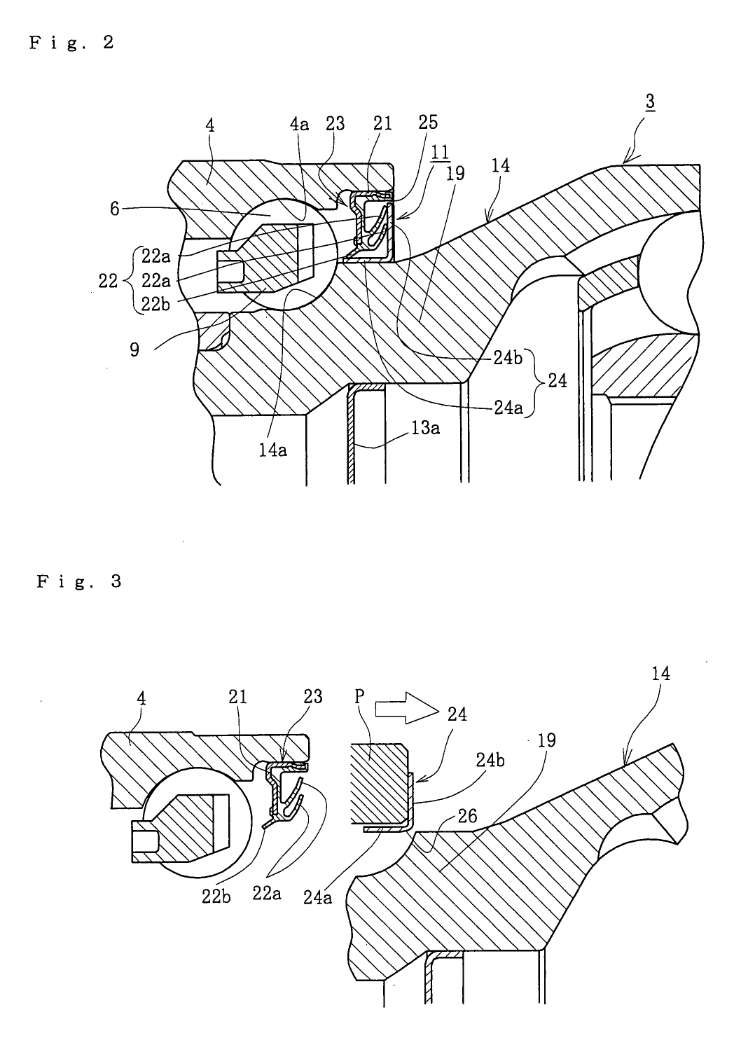

FIG. 1 is a longitudinal-section view of an embodiment of a wheel bearing apparatus of the present disclosure. FIG. 2 is a partially enlarged sectional view of FIG. 1. In the description below, the term “outboard side” of the wheel bearing apparatus denotes a side positioned outside of the vehicle body. The term “inboard side” of the wheel bearing apparatus denotes a side positioned inside of the vehicle body when the wheel bearing apparatus is mounted on the vehicle body.

The wheel bearing apparatus is formed as a unit of a wheel hub 1, a double row rolling bearing 2 and a constant velocity universal joint 3. The double row rolling bearing 2 comprises an outer member 4, an inner member 5 and double row rolling elements (balls) 6, 6. The inner member 5 includes the wheel hub 1 and an outer joint member 14 fit into the wheel hub 1.

The outer member 4 is made of medium carbon steel such as S53C that includes carbon of 0.40˜0.80% by weight. The outer member 4 is integrally formed with a body mounting flange 4b on its outer circumference. The body flange 4b is adapted to be mounted on the body (not shown) of a vehicle. Also, the outer member 4 is formed with double row outer raceway surfaces 4a, 4a on its inner circumference. The double row outer raceway surfaces 4a, 4a are hardened by high frequency induction hardening to have a hardness of 58˜64 HRC.

The wheel hub 1 is made of medium carbon steel such as S53C that includes carbon of 0.40˜0.80% by weight. The wheel hub 1 has a wheel mounting flange 7 at its outboard side end. The wheel mounting flange 7 mounts a wheel (not shown) thereon via a plurality of hub bolts 8 equidistantly arranged along the periphery of the wheel mounting flange 7. The wheel hub 1 has one inner raceway surface 1a on its outer circumference. The inner raceway surface 1a is arranged opposite to one of the double row outer raceway surfaces 4a, 4a. A cylindrical portion 1b extends from the wheel mounting flange 7. The wheel hub 1 is formed with a hardened layer having a surface hardness of 58˜64 HRC by high frequency induction hardening. The hardened layer extends from a seal land portion, which sliding contacts an outboard side seal 10, to the inner raceway surface 1a and the cylindrical portion 1b. This not only improves the anti-friction characteristics of the seal land portion at the base of the wheel mounting flange 7 but improves the durability of the wheel hub 1 by providing a sufficient mechanical strength against the rotary bending load applied to the wheel mounting flange 7.

The constant velocity universal joint 3 comprises the outer joint member 14, a joint inner ring 15, cage 16 and torque transmitting balls 17. The outer joint member 14 is made of medium carbon steel such as S53C that includes carbon of 0.40˜0.80% by weight. The outer joint member 14 has a cup shaped mouth portion 18, a shoulder portion 19, forming the bottom of the mouth portion 18, and a cylindrical shaft portion 20, axially extending from the shoulder portion 19, which are integrally formed with each other. The shaft portion 20 is formed with a cylindrical spigot portion 20a fit into the cylindrical portion 1b of the wheel hub 1 via a predetermined radial gap. A fitting portion 20b is formed at the end of the spigot portion 20a.

An inner surface of the mouth portion 18 is formed with axially extending curved track grooves 18a. An outer surface of the joint inner ring 15 is formed with track grooves 15a, corresponding to the track grooves 18a. An outer circumferential surface of the shoulder portion 19 is formed with inner raceway surface 14a, that corresponds to one of the double row raceway surfaces 4a, 4a. A hardened layer, having the surface hardness of HRC 58˜64, is formed by high frequency induction heating. The hardened layer is in a region from a seal land portion, which sliding contacts the inboard side seal 11, to the inner raceway surface 14a and the shaft portion 20. The fitting portion 20b, itself, remains as raw material without being hardened after having been forged.

Double row rolling elements (balls) 6, 6 are arranged between the double row outer raceway surfaces 4a, 4a of the outer member 4 and corresponding double row inner raceway surfaces 1a, 14a. The balls 6, 6 are held freely rollably by cages 9, 9. Seals 10, 11 are arranged at both ends of the outer member 4 in order to prevent leakage of grease contained within the bearing as well as to prohibit the ingress of rain water or dust into the inside of the bearing. Although shown as a double row angular ball bearing using balls as the rolling elements 6, 6, the present disclosure is not limited to such an embodiment. Thus, a double row tapered roller bearing using tapered rollers as its rolling elements may be used.

The inner circumferential surface of the wheel hub 1 is formed with an irregular portion 12 formed with a hardened layer having a surface hardness of 54˜64 HRC. It is preferable to carry out heat treatment using high frequency induction heating which can perform local heating and easily set the depth of hardened layer. The irregular portion 12 is formed with a crisscross knurl pattern formed by combining a plurality of independent annular grooves, formed by a lathe, and a plurality of axial grooves, formed by broaching, as orthogonally crossed grooves or mutually inclined helical grooves. Each projection forming the irregular portion 12 may be pointed like a pyramid to increase the biting ability of the irregular portion 12.

The shaft portion 20 of the outer joint member 14 is fit into the wheel hub 1 until the shoulder portion 19 of the outer joint member 14 abuts the end face of the cylindrical portion 1b of the wheel hub 1. The wheel hub 1 and the outer joint member 14 are integrally connected to each other by inserting a radially expanding tool, such as a mandrel, into the bore of the fitting portion 20b of the shaft portion 20. The fitting portion 20b is plastically deformed and forced to bite into the hardened irregular portion 12. Thus, the wheel hub and the outer joint member can be integrally connected by plastically deforming the fitting portion of the shaft portion of the outer joint member and by forcing the fitting portion to bite into a hardened irregular portion formed on an inner circumferential surface of the wheel hub without the need to control the pre-load by fastening a nut as is conventional. This makes it possible to reduce the size and weight of the wheel bearing apparatus and to improve the strength and durability of the wheel hub as well as to maintain its pre-load for a long term. An end cap 13a, mounted within the shaft portion 20, prevents leakage of grease contained within the mouth portion 18. Another end cap 13b, mounted on an opening of the wheel hub 1, prevents ingress of rain water or muddy water into the plastically deformed connection between the wheel hub 1 and the outer joint member 14 to prevent generation of erosion therein.

The wheel hub 1 and the outer joint member 14 can be secured to each other by other ways, such as by inserting the shaft portion 20 of the outer joint member 14 so that the end of the shaft portion 20 projects from the wheel hub 1 and by plastically deforming the projected end radially outward to form a caulked portion therebetween.

As shown in an enlarged view of FIG. 2, the inboard side seal 11 comprises a sealing ring 23. The sealing ring 23 includes a generally annular metal core 21 having a substantially L-shaped cross-section adapted to be fit into the outer member 4. A sealing member 22 is adapted to be integrally adhered on the metal core 21, via vulcanized adhesion. A slinger 24 is adapted to be arranged opposite to the sealing ring 23. The slinger 24 is generally annular and has a substantially L-shaped cross-section.

The metal core 21 is made by press forming of austenitic stainless steel sheet (JIS SUS 304 etc) or preserved cold rolled sheet (JIS SPCC etc). The slinger 24 comprises a cylindrical portion 24a fit onto the shoulder portion 19 of the outer joint member 14. A standing portion 24b extends radially outward from the cylindrical portion 24a. The slinger is made by press forming of austenitic stainless steel sheet (JIS SUS 304 etc) or preserved cold rolled sheet (JIS SPCC etc).

The sealing member 22 is made of an elastic member such as rubber and has three sealing lips. It includes a pair of side lips 22a, 22a and a grease lip 22b. The tip edges of the side lips 22a are adapted to contact the outboard side surface of the standing portion 24b of the slinger 24. The tip edge of the grease lip 22b is adapted to contact the cylindrical portion 24a of the slinger 24. The tip of the standing portion 24b of the slinger 24 is opposed to the sealing ring 23 and keeps a slight radial gap therebetween to form a labyrinth seal 25. This structure exhibits sufficient sealability under circumstances where plenty of foreign matters such as rain water or muddy water, exist.

The method of assembling the inboard side seal 11 will be described with reference to FIG. 3.

Each bearing unit, with the balls 6 previously mounted and held by the cage 9, is fit into each outer raceway surface 4a of the outer member 4. The outboard side seal 10 (FIG. 1) is fit into the outer member 4. A predetermined amount of grease is charged within the outer member 4. The sealing ring 23 of the inboard side seal 11 is fit into the outer member 4. The charging of grease may be performed after fitting of the sealing ring 23.

The slinger 24 is press fit onto the shoulder portion 19 of the outer joint member 14 using a press fitting tool P. The press fit tool is designed to abut the outboard side surface of the standing portion 24b of the slinger 24. Abutment of the tool P against the outboard side surface of the standing portion 24b of the slinger is different from the conventional manner where the tool P is abutted against the end face of the cylindrical portion 24a of the slinger 24. This enables carrying out exact positioning of the slinger 24 only by controlling the press fitting stroke of the tool P without being influenced by variation in dimension of width of the slinger 24. Accordingly, it is possible to further improve the accuracy in assembly and positioning of the slinger 24 as well as to exactly set the interference contact of the side lips 22a against the slinger 24. Thus it is possible to provide a wheel bearing apparatus for a vehicle where the inboard side seal of the fourth generation type can be efficiently assembled and the sealability is improved. In order to suppress deformation of the slinger 24 during press fitting, it is preferable to use a steel sheet for the slinger 24 having a thickness larger than that for the metal core 21. The thickness is preferably 0.7˜1.2 mm, more preferably 0.8˜1.0 mm, as compared with a conventional thickness of 0.6 mm.

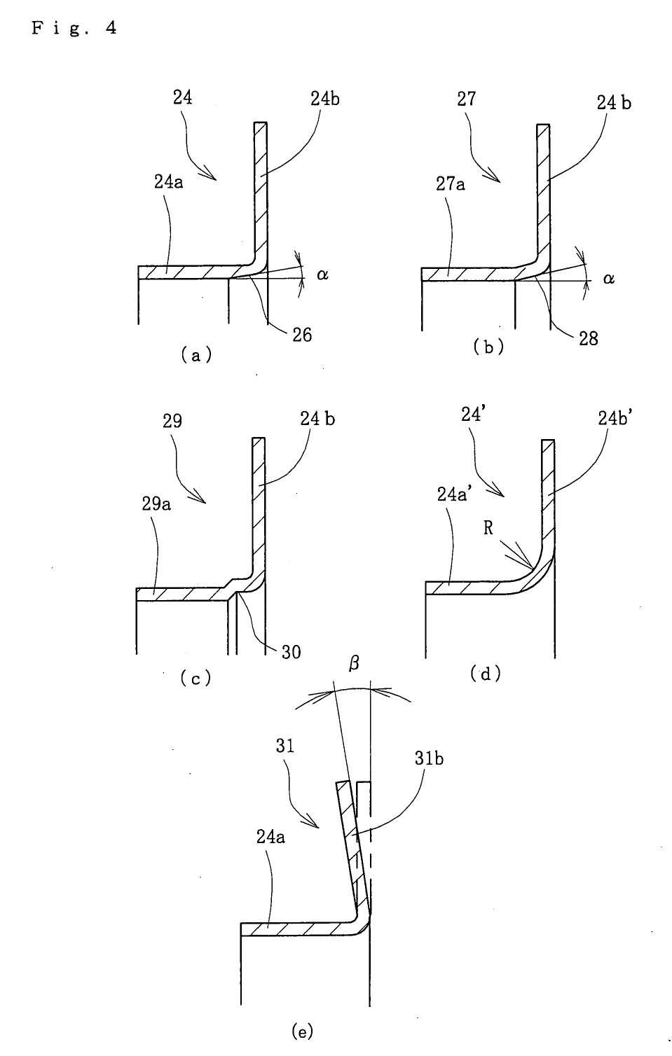

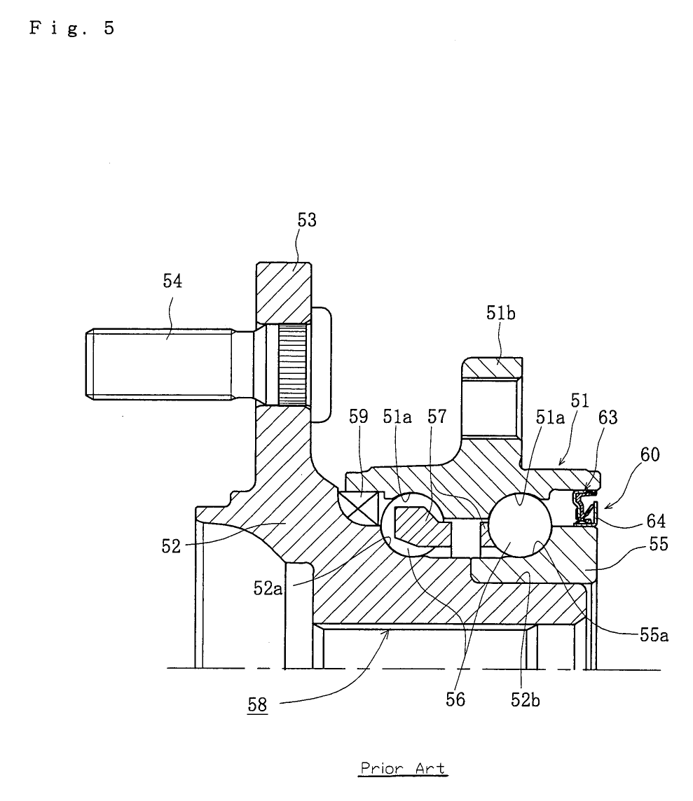

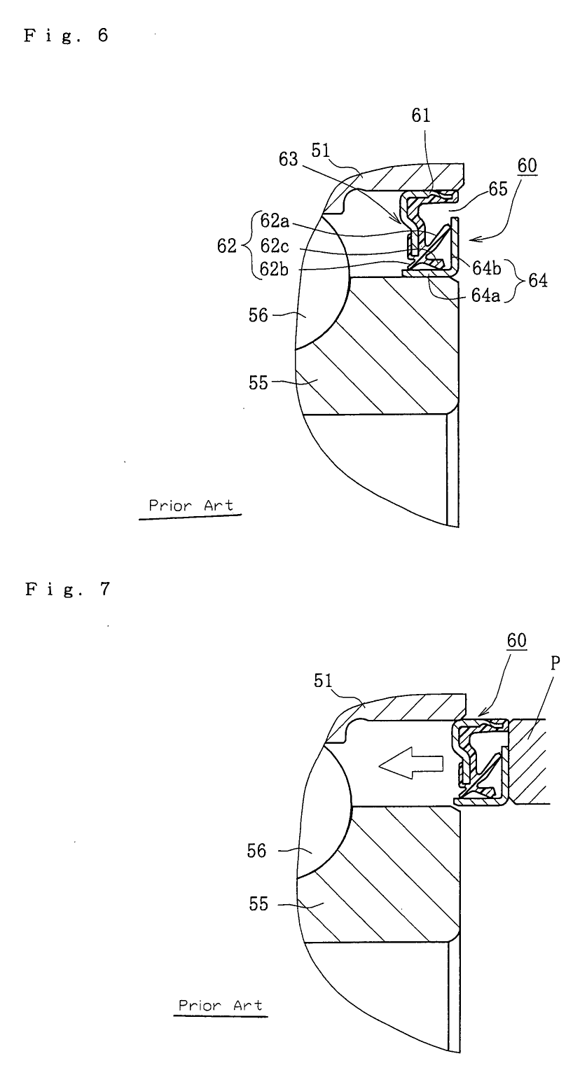

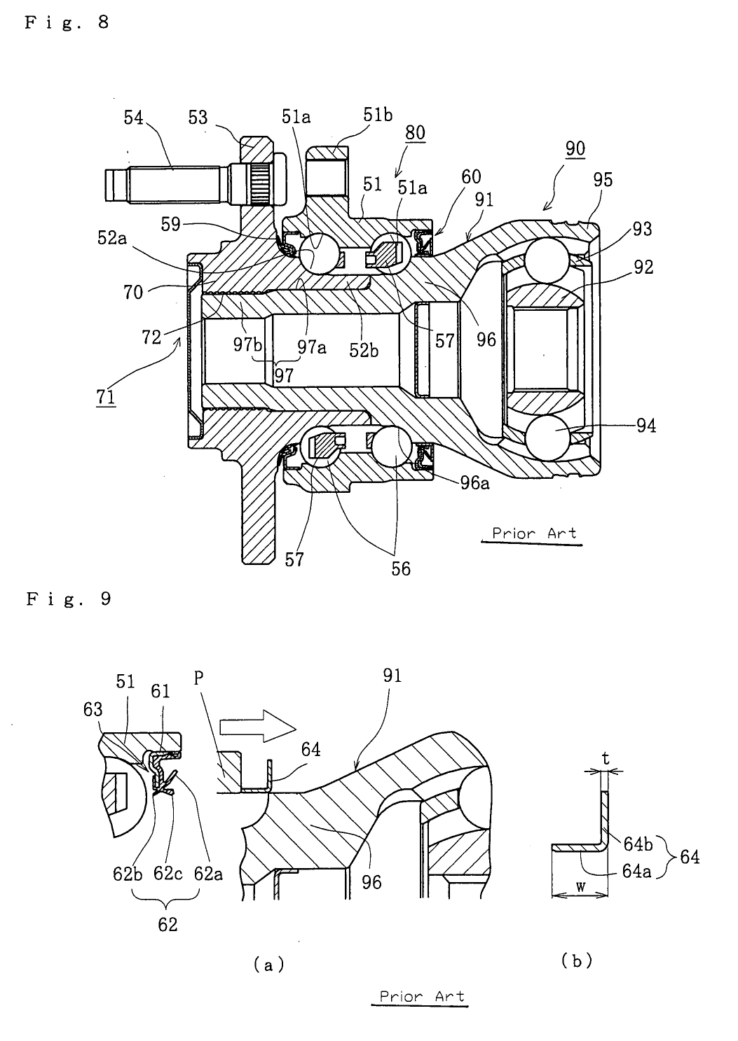

Other than increasing the thickness of the slinger 24 to suppress the deformation of the slinger 24, it is possible to adopt those slingers shown in FIGS. 4(a)˜4(e) as the slinger.

FIG. 4(a) shows the slinger 24 of a preferable embodiment invention and comprises the cylindrical portion 24a and the standing portion 24b extending radially outward from the cylindrical portion 24a. A chamfered portion 26, having a predetermined inclined angle α, is formed by cutting or pressing process at the base of the cylindrical portion 24a forming a starting point of the press fitting. Provision of the chamfered portion (guiding portion) 26 help to prevent the deformation or pinching of the slinger 24 during the press fitting operation and to improve the seating of the slinger 24 against the shoulder portion 19 (FIG. 1) of the outer joint member 14. This also improves the accuracy in assembly of the slinger 24 and assure a desirable interference contact of the side lips 22a (FIG. 2) against the slinger 24.

A slinger 27 shown in FIG. 4(b) is a modification of the slinger 24 and comprises a cylindrical portion 27a and a standing portion 24b extending radially outward from the cylindrical portion 27a. The connected portion between the standing portion 24b and the cylindrical portion 27a is formed by a tapered portion (guiding portion) 28 with a predetermined inclination of angle α. This prevents the deformation or pinching of the slinger 27 during the press fitting operation and improves the seating of the slinger 27 against the shoulder portion 19 (FIG. 1) of the outer joint member 14.

A slinger 29 shown in FIG. 4(c) comprises a cylindrical portion 29a and a standing portion 24b extending radially outward from the cylindrical portion 29a. The connected portion between the standing portion 24b and the cylindrical portion 29a is formed by a stepped portion (guiding portion) 30. This increases the rigidity of the slinger 29 and prevents the deformation or pinching of the slinger 29 during the press fitting operation and improves the seating of the slinger 29 against the shoulder portion 19 (FIG. 1) of the outer joint member 14.

Slinger 24′, shown in FIG. 4(d), comprises a cylindrical portion 24a′ and a standing portion 24b′ extending radially outward from the cylindrical portion 24a′. The connected portion between the standing portion 24b′ and the cylindrical portion 24a′ is formed by a rounded corner having a radius “R” larger than the thickness of the slinger 24′. This enables carrying out a smooth press fitting operation and improves the seating of the slinger 24′ against the shoulder portion 19 (FIG. 1) of the outer joint member 14.

Slinger 31, shown in FIG. 4(e), comprises a cylindrical portion 24a and a standing portion 31b extending radially outward from the cylindrical portion 24a. The standing portion 31b is formed so that it inclines toward the outboard side at a predetermined angle β relative to vertical. This assures a desirable perpendicularity and improves accuracy of the slinger 31 after assembly. Thus, this enables the interference contact of the side lips to be set at a predetermined value.

The wheel bearing apparatus of the present disclosure can be applied to wheel bearing apparatus of the fourth generation type that is formed by a unit of a wheel hub, a double row rolling bearing and a constant velocity universal joint.

The present disclosure has been described with reference to the preferred embodiment. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1-5. (canceled)

6. A wheel bearing apparatus formed by a unit of a wheel hub, a double row rolling bearing and a constant velocity universal joint, the double row rolling bearing comprising;
an outer member formed with double row outer raceway surfaces on its inner circumferential surface;
an inner member including the wheel hub having a wheel mounting flange integrally formed at one end, one double row inner raceway surfaces formed on said inner member and arranged opposite to the double row outer raceway surfaces, a cylindrical portion axially extending from the wheel mounting flange and said inner member including an outer joint member of the constant velocity universal joint, the outer joint member formed with another double row inner raceway surface and a shaft portion axially extending from said other double row inner raceway surface;
double row rolling elements rollably arranged between the outer and inner raceway surfaces;
seals mounted in annular openings formed at opposite ends of the outer member and the inner member;
the wheel hub and the outer joint member are integrally connected by plastically deforming the shaft portion of the outer joint member into the wheel hub;
the seal on an inboard side of said seals comprises a sealing ring including a generally annular metal core having a substantially L cross-section, said sealing ring adapted to be fit into the outer member, and a sealing member, having side lips, to adapt to be integrally adhered on the metal core; and
a generally annular slinger adapted to be arranged opposite to the sealing ring, said slinger having a substantially L shaped cross-section formed by a cylindrical portion, adapted to be fit onto the inner member, and a standing portion extending radially outward from the cylindrical portion; and
a guiding portion is formed on the base of the cylindrical portion of the slinger to prevent generation of deformation or pinching during press fitting of the slinger.

7. The wheel bearing apparatus of claim 6, wherein the wheel hub and the outer joint member are integrally connected by plastically deforming a fitting portion formed in the shaft portion of the outer joint member and by forcing the fitting portion to bite into a hardened irregular portion formed on an inner circumferential surface of the wheel hub.

8. The wheel bearing apparatus of claim 6, wherein the thickness of the slinger is larger than that of the metal core and set within a range of 0.8 mm˜1.0 mm.

9. The method of assembling a wheel bearing apparatus of claim 6, comprising the steps of fitting the sealing ring of the seal of an inboard side into the outer member; and
press fitting the slinger by using a press fitting tool adapted to abut the outboard side face of the standing portion of the slinger.

10. The method of assembling a wheel bearing apparatus of claim 9, wherein the standing portion of the slinger is previously formed so that it is inclined toward the outboard side at a predetermined angle.
